(19) United States
(12) Patent Application Publication
(10) Pub. No.: US 2013/0234982 A1
(43) Pub. Date: Sep. 12, 2013

(54) MOBILE TERMINAL AND DISPLAY CONTROL METHOD

(71) Applicant: PANTECH CO., LTD., Seoul (KR)

(72) Inventor: Choon Kwon KANG, Seoul (KR)

(73) Assignee: Pantech Co., Ltd., Seoul (KR)

(21) Appl. No.: 13/782,162

(22) Filed: Mar. 1, 2013

(30) Foreign Application Priority Data
Mar. 7, 2012 (KR) 10-2012-0023439

(51) Int. Cl. G06F 3/044

(52) U.S. Cl. CPC G06F 3/044
USPC 345/174

(57) ABSTRACT

A method for controlling an active area includes detecting a touch input on a touch area of a display unit; determining validity of the touch input; converting at least a portion of the touch area corresponding to the first touch input to a virtual bezel area if the touch input is determined to be invalid; and performing a command based on the validity of the touch input. A mobile terminal includes a display unit including an active area; a touch input unit to detect a touch input on a touch area of the display unit; and a control unit to determine validity of the detected touch input, to convert at least a portion of the touch area corresponding to the first touch input to a virtual bezel area if the touch input is determined to be invalid, and to perform a command based on the validity of the touch input.

### CROSS-REFERENCE TO RELATED APPLICATION

This application claims priority from and the benefit under 35 U.S.C. §119(a) of Korean Patent Application No. 10-2012-0023439, filed on Mar. 7, 2012, which is hereby incorporated by reference for all purposes as if fully set forth herein.

### BACKGROUND

1. Field

Exemplary embodiments of the present invention relate to a technique for determining whether a touch input detected in a touch area is associated with gripping of a mobile terminal and controlling a touch command associated with the touch input based on the determined result.

2. Discussion of the Background

A general display apparatus may include a display area and a bezel surrounding edges of the display area.

FIG. 1 illustrates a display apparatus according to the related art.

Referring to FIG. 1, the display apparatus may include a display area 101 in which a touch can be inputted, and a bezel 103 surrounding the display area 101.

However, with a recent preference for a larger display, techniques for reducing the width of the bezel have been suggested to expand the display area in the display apparatus. The display apparatus with the reduced width bezel may be referred to as a narrow-bezel display apparatus.

For a narrow-bezel display apparatus to be applied to a mobile terminal, such as a mobile communication terminal, a tablet personal computer (PC), and the like, there may be a limitation in how far the width of the bezel may be reduced since the bezel of the display unit may be used to grip the mobile terminal. More specifically, because the bezel may not detect a touch, a user may grip the mobile terminal at the bezel without generating unintended touch input. Further, when the bezel of the display apparatus is reduced beyond a reference width, a user may grip the display area where touch is detected when the user grips the mobile terminal. Accordingly, since a touch panel may be applied to the display unit of the mobile terminal to process a touch input of the user, the grip may be recognized as a touch input and thus, processed as an input from the user, thereby causing an error in touch recognition.

### SUMMARY

Exemplary embodiments of the present invention provide an apparatus and a method for identifying a valid input signal in a terminal.

Additional features of the invention will be set forth in the description which follows, and in part will be apparent from the description, or may be learned by practice of the invention.

Exemplary embodiments of the present invention provide a method for controlling an active area of a display unit including detecting a first touch input on a touch area of the display unit; determining validity of the first touch input; converting at least a portion of the touch area corresponding to the first touch input to a virtual bezel area if the first touch input is determined to be invalid; and performing a command based on the validity of the first touch input.

Exemplary embodiments of the present invention provide a mobile terminal including a display unit including an active area; a touch input unit to detect a first touch input on a touch area of the display unit; and a control unit to determine validity of the detected first touch input, to convert at least a portion of the touch area corresponding to the first touch input to a virtual bezel area if the first touch input is determined to be invalid, and to perform a command based on the validity of the first touch input.

Exemplary embodiments of the present invention provide a method for controlling an active area of a display unit including detecting a touch input on a determination area of the display unit; determining whether the touch input is associated with gripping a mobile terminal; converting at least a portion of the determination area corresponding to the touch input to a virtual bezel area if the touch input is determined to be associated with gripping the mobile terminal; invalidating a command corresponding to the touch input; and adjusting the active area with respect to the virtual bezel area.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating a display apparatus according to the related art.

FIG. 2 is a diagram illustrating a touch area of a display unit of a mobile terminal according to an exemplary embodiment of the present invention.

FIG. 3A, FIG. 3B, and FIG. 3C are diagrams illustrating a touch area of a display unit of a mobile terminal according to an exemplary embodiment of the present invention.

FIG. 4 is a block diagram illustrating a configuration of a mobile terminal according to an exemplary embodiment of the present invention.

FIG. 5A and FIG. 5B are diagrams illustrating an operation of a mobile terminal according to an exemplary embodiment of the present invention.

FIG. 6A, FIG. 6B, FIG. 6C, FIG. 6D, FIG. 6E, and FIG. 6F are diagrams illustrating a display control operation of a mobile terminal according to an exemplary embodiment of the present invention.

FIG. 7A, FIG. 7B, FIG. 7C, FIG. 7D, FIG. 7E, and FIG. 7F are diagrams illustrating a display control operation of a mobile terminal according to an exemplary embodiment of the present invention.

FIG. 8A and FIG. 8B are diagrams illustrating a display orientation control of a mobile terminal according to an exemplary embodiment of the present invention.

FIG. 9A, FIG. 9B, and FIG. 9C are diagrams illustrating a display direction control of a mobile terminal according to an exemplary embodiment of the present invention.

FIG. 10 is a diagram illustrating a determination area setting operation of a mobile terminal according to an exemplary embodiment of the present invention.

FIG. 11 is a flowchart illustrating a display control method according to an exemplary embodiment of the present invention.

FIG. 12 is a flowchart illustrating an operational structure of a user interface according to an exemplary embodiment of the present invention.

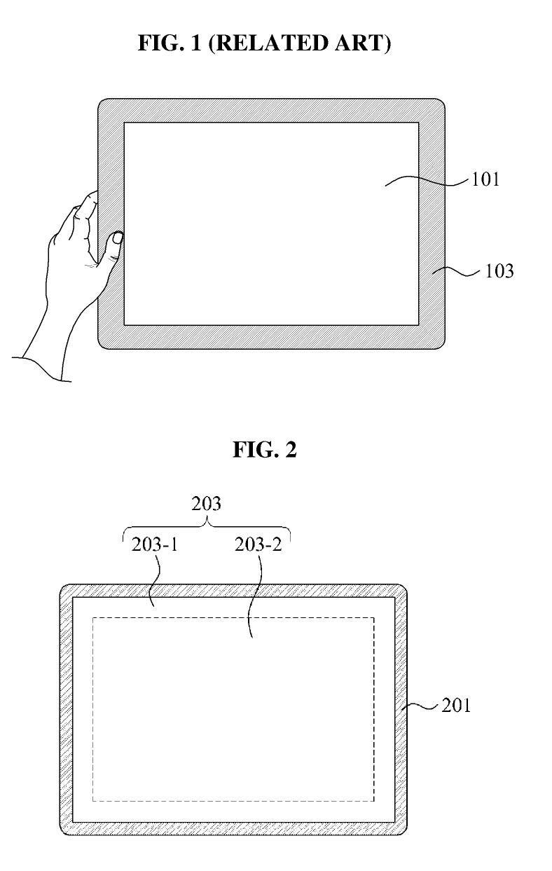

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity.

It will be understood that when an element is referred to as being “connected to” another element, it can be directly connected to the other element, or intervening elements may be present. Further, it will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, areas, integers, steps, operations, elements, and/or components, but do not preclude the presence or addition of one or more other features, regions, areas, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

Hereinafter, a mobile terminal and a display control method according to exemplary embodiments of the present invention are described in more detail. The mobile terminal may include a variety of handheld devices, for example, a mobile communication terminal, a tablet personal computer (PC), and the like. The mobile terminal may include a device with a touch input unit to process an input of a touch or a touch input on an area of a display screen or a touch area of a display unit. However, aspects of the invention are not limited to a mobile terminal, and may be applied to a variety of display apparatuses.

A touch area or region may refer to or correspond to an area on the display screen of a display unit that may detect a touch input. The detected touch input may or may not be processed based on a location of the touch input. The entire touch area or a portion thereof may display information to a user. An area may be referred to as a region, and a region may be referred to as an area.

A display area or region may refer to or correspond to an area on the display screen of a display unit, in which display information may be displayed. More specifically, the display area may include a view area among an area of a display panel and an area of a touch panel. The display area may overlap the touch area, and may be the same size, larger, or smaller than the touch area.

A bezel may refer to or correspond to a physical bezel or frame that may be formed along the edges of the display unit of the mobile terminal.

A determination area or region may refer to or correspond to an area segment of the touch area set to determine whether a detected touch is a valid touch or a touch associated with a gripping of the mobile terminal when the touch is inputted by a user. The determination area may be located along the edges of the touch area, more specifically, surrounding border inside of the physical bezel. However, aspects of the invention are not limited thereto, such that the determination area may be designated at various locations of the touch area.

A command execution area or region may refer to or correspond to an area other than the determination area within the touch area. The determination area and the command execution area may be virtually divided to determine whether to process a touch inputted by a user as a grip or a valid touch input. More specifically, the command execution area may process the detected touch input without an additional determination operation to determine the validity of the detected touch input. However aspects of the invention are not limited thereto, such that the command execution area may coincide with the determination area. For example, the determination area may cover the entire display screen.

A virtual bezel area or region may refer to or correspond to an area in the touch area of which is determined to be an area that may be normally gripped by a user. More specifically, the virtual bezel area may be an area in which the touch input associated with gripping of the mobile terminal, or other similar device, may be determined as an invalid touch input. Further, the virtual bezel area may correspond to a predetermined area in the touch area set to operate like the physical bezel when a touch input associated with the gripping of the mobile terminal is inputted by a user. In the virtual bezel area, detected touch input may be invalidated, and display information may or may not be displayed. However, aspects of the invention are not limited thereto, such that the virtual bezel area may be manually adjusted by a user or automatically adjusted by the display unit based on historical data or current usage. For example, if the display unit determines a user other than the normal user, who may have larger hands, is gripping the mobile terminal, the display unit may adjust the size of the virtual bezel area to accommodate the other user.

An active area or region may refer to or correspond to an area other than the virtual bezel area among the touch area, in which touch input may be processed and information may be displayed. The active area may include the command execution area and portions of determination area that corresponds to a valid touch input. When the size of the virtual bezel area is adjusted, the active area may also be adjusted. Further, the active area may overlap the display area, and may be smaller, larger, or the same size as the display area.

FIG. 2 is a diagram illustrating a touch area of a display unit of a mobile terminal according to an exemplary embodiment of the present invention.

Referring to FIG. 2, the mobile terminal may include a touch area 203 and a bezel 201. The touch area 203 may include a determination area 203-1 and a command execution area 203-2.

The bezel 201 may correspond to a physical bezel or frame of a display apparatus, and the touch area 203 may correspond to an area in which information processed by the mobile terminal, such as images, may be displayed and an input of a touch provided by a user may be detected. However, aspects of the invention are not limited thereto, such that the display apparatus may not include a bezel, for example, a full screen display. The determination area 203-1 may correspond to a portion of the touch area 203 in which a determination of whether a touch input is a valid input or an input associated with gripping or holding of the mobile terminal. The command execution area 203-2 may correspond to a portion of the touch area 203 that may process the touch inputs detected therein as valid inputs. In an example, the command execution area 203-2 may be separate from the determination area 203-1 among the touch area 203.

A portion of a determination area that may be determined to be associated with gripping or holding of the mobile terminal may be temporarily allocated as a virtual bezel area. Other portions or remaining portions of the determination area may be allocated as an active area and not as a virtual bezel area. Accordingly, the touch area 203 may be expanded.

In the allocation of the determination area 203-1, N number of touch channels may be located adjacently along the edges of the touch area 203 of the mobile terminal, which may collectively be referred to as the determination area 203-1, in which N is a natural number. In an example, the determination area 203-1 may refer to a single integrated determination area or a plurality of separate determination areas that may be joined together. When the touch panel of the mobile terminal includes a plurality of x-axis touch channels and a plurality of y-axis touch channels, more specifically, when the touch area 203 includes a plurality of touch channels arranged at predetermined intervals along each of the x-axis and the y-axis, the mobile terminal may allocate, as the determination area 203-1, two x-axis touch channels and two y-axis touch channels, each located at opposite edges of the touch area 203. For example, when the touch panel includes forty channels 0 to 39 along an x-axis, channels 0, 1 and 38, 39, which may correspond to the left end and right end along the x-axis, respectively, may be allocated as the determination area 203-1.

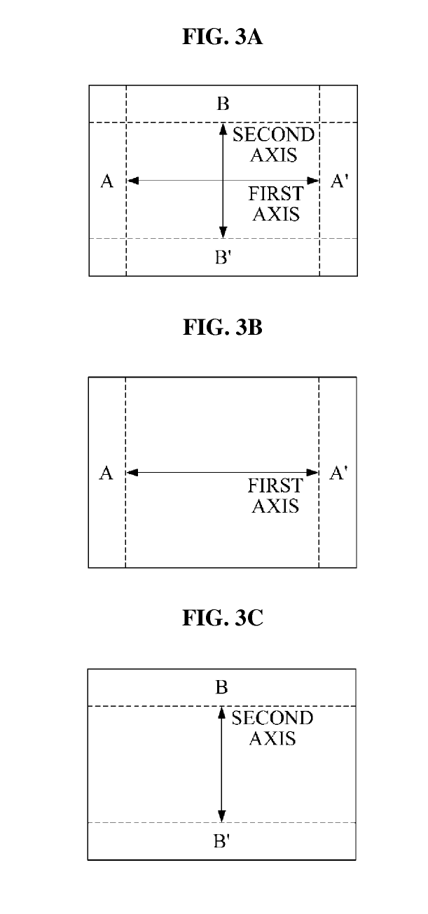

FIG. 3A, FIG. 3B, and FIG. 3C are diagrams illustrating a touch area of the display unit of the mobile terminal according to an exemplary embodiment of the present invention.

As shown in FIG. 3A, the mobile terminal may include four determination areas A, A′, B, and B′ respectively formed at the left, right, top, and bottom portions of the display screen of the mobile terminal. More specifically, in the allocation of the determination areas in the touch area, the mobile terminal may include, based on a predetermined first axis, a first determination area A formed at one end of the first axis and a second determination area A′ formed at an opposite end of the first axis as shown in FIG. 3B. In this instance, the first determination area A and the second determination area A′ may be parallel to each other. Similarly, the mobile terminal may include, based on a second axis perpendicular to the first axis, a third determination area B formed at one end of the second axis and a fourth determination area B′ formed at an opposite end of the second axis as shown in FIG. 3C. The third determination area B and the fourth determination area B′ may be parallel to each other. Here, the first determination area A and the second determination area A′ may be perpendicular to the third determination area B and the fourth determination area B′.

As shown in FIG. 3B and FIG. 3C, the determination areas may be allocated in the touch area based on a single axis. More specifically, the determination area A, the determination area A′, the determination area B, and the determination area B′ may be respectively allocated in the touch area at two symmetrically opposite ends based on the first axis and the second axis. However, aspects of the invention are not limited thereto, such that the determination areas may be designated to portions where two or more determination areas may overlap (e.g., a corner portion of the touch area), or areas where no such overlap exists. Further, the determination area may be designated to a single side of the axis, such that the determination area may be provided on the left side, but not on the right side, or provided on the top side but not at the bottom side.

As described foregoing, the determination area and the command execution area may not be physically divided and may be virtually divided to determine whether a touch inputted by a user in the touch area is a valid touch or an invalid touch, such as a touch input associated with gripping of the mobile terminal. Further, displaying and touch input processing may be performed in the determination area and the touch area in the same manner. More specifically, some portions of the determination area may be operated in the same manner as the command execution area, and some portions of the determination area may be operated similar to a virtual bezel area.

Accordingly, when a touch associated with gripping or holding of the mobile terminal is not inputted, the mobile terminal may use the touch area without dividing the touch area into the determination area and the command execution area. For example, when the mobile terminal displays a home view or a program execution view using the touch area including both the determination area and the command execution area, the mobile terminal may use the touch area without being limited to the command execution area, thereby maximizing use of the touch area. More specifically, when the touch input is determined to be a valid touch input, the determination area may behave similar to or the same as the command execution area, thereby effectively increasing the command execution area. In this instance, when the touch input is determined to be a valid touch input, the effective display area may be the same size as the touch area.

In contrast, when a touch input is determined to be associated with the gripping or holding of the mobile terminal, the mobile terminal may convert a portion of the determination area in which the inputted touch is associated with the gripping or holding of the mobile terminal into a virtual bezel area. In this instance, the mobile terminal may convert the portion of the determination area in which the inputted touch is determined to be associated with the gripping or holding of the mobile terminal into a virtual bezel area. The virtual bezel area may correspond to a predetermined portion of the touch area set as a virtual bezel to allow a user to grip like a physical bezel or a portion of the touch area that may be temporarily allocated as the virtual bezel area based on the detected touch input. A touch inputted by a user in the virtual bezel area may be invalidated and a corresponding command may not be processed or executed. Accordingly, a likelihood of executing an unintended operation or command in response to detecting a touch input associated with the gripping or holding of the mobile terminal in the touch area may be reduced or prevented.

Further, portions of the determination area other than the portion of the determination area that was converted into the virtual bezel area may be allocated as an active area together with the command execution area. Accordingly, the portion of the determination area affected by a touch associated with gripping or holding the mobile terminal may be allocated as a virtual bezel area, and the other portions of the determination area that are not affected by the touch associated with gripping or holding of the mobile terminal may be allocated as an active area.

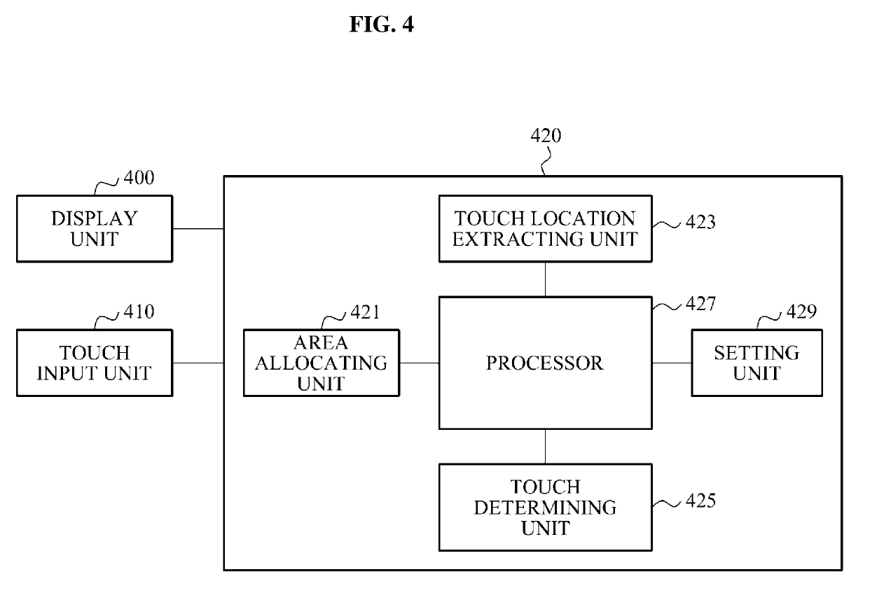

FIG. 4 is a block diagram illustrating a configuration of the mobile terminal according to an exemplary embodiment of the present invention.

Referring to FIG. 4, the mobile terminal may include a display unit 400, a touch input unit 410, and a control unit 420.

The display unit 400 may display information processed by the mobile terminal, and the touch input unit 410 may detect an input of a touch provided by a user in a touch area.

The control unit 420 may determine whether the touch inputted by the user in the touch area is a valid input. More specifically, the control unit 420 may determine whether the touch inputted by the user is associated with a gripping or holding of the mobile terminal, and may allocate a portion of the determination area as a virtual bezel area, an active area, or a command execution area based on the determined result.

The control unit 420 may include an area allocating unit 421, a touch location extracting unit 423, a touch determining unit 425, a processor 427, and a setting unit 429.

The area allocating unit 421 may allocate a portion of the touch area into a plurality of determination areas. The area allocating unit 421 may allocate N number of touch channels located at the edges of the touch area as determination areas, in which N is a natural number. More specifically, when the touch area includes a plurality of touch channels arranged at a predetermined interval along an x-axis and a y-axis, the area allocating unit 421 may allocate, for example, each of two x-axis touch channels and two y-axis touch channels located at two opposite edges of the touch area, as determination areas. However, aspects of the invention are not limited thereto, such that the area allocating unit 421 may allocate a portion of the touch area as a determination area according to a viewing direction or orientation.

In an example, in the touch area, the area allocating unit 421 may allocate, based on a first axis, a first determination area located at one end of the first axis and a second determination area located at an opposite end parallel to the first axis. Also, in the touch area, the area allocating unit 421 may allocate, based on a second axis perpendicular to the first axis, a third determination area located at one end of the second axis and a fourth determination area located at an opposite end parallel to the second axis.

The touch location extracting unit 423 may extract location information of a determination area in which the touch is inputted. More specifically, the touch location extracting unit 423 may detect whether the touch inputted by the user, which may be transmitted from the touch input unit 410, is inputted in the determination area. The touch location extracting unit 423 may be included in the touch input unit 410 or may be separate from the touch input unit 410.

The touch determining unit 425 may determine whether the touch inputted by the user in the determination area is a valid input or an invalid input. In an example, if the touch input is determined to be associated with the gripping or holding of the mobile terminal, the touch input may be determined to be invalid. When the touch input is determined to be invalid, the touch determining unit 425 may convert at least a portion of the determination area in which the touch may be inputted into a virtual bezel area. In this instance, while the touch determined to be associated with the gripping and holding of the mobile terminal is allocated and maintained as the virtual bezel area, the area allocating unit 421 may allocate other portions of the determination area as an active area, along with the command execution area. The active area may detect and process a command corresponding to the touch input similar or the same as the command execution area. Accordingly, the effective command execution area may be increased by allocating some portions of the determination area as the active area.

More specifically, the touch determining unit 425 may determine whether the touch input is associated with the gripping or holding of the mobile terminal and may convert at least a portion of the determination area in which the touch input is detected into a virtual bezel area. Further, the area allocating unit 421 may allocate other portions of the determination area as an active area so that display information, such as a program icon and a program execution view, may be displayed on the effectively increased command execution area. Accordingly, information provided in the virtual bezel area may be displayed, and not concealed by the touch input associated with gripping of the mobile terminal.

When determining whether the touch input is an invalid input or an input associated with gripping or holding the mobile terminal, the touch determining unit 425 may determine the touch input to be associated with gripping or holding the mobile terminal when a surface area of touch input detected in the determination area is greater than or equal to a predetermined value. More specifically, the touch determining unit 425 may determine the touch input to be associated with gripping of the mobile terminal when the surface area of the touch input detected in the determination area is greater than or equal to a predetermined area. For example, the surface area of the touch input may be recognized in the determination area within four node points, more specifically, node points corresponding to one cell, which may be formed by intersections between a plurality of touch channels arranged along each of an x-axis and a y-axis at an interval of 5 millimeters (mm). The touch determining unit 425 may determine the touch to be associated with the gripping of the mobile terminal. More specifically, the touch determining unit 425 may determine that the touch input to be an invalid input since the surface area of the touch input detected in the determination area is larger than 5 mm×5 mm.

Further, when a plurality of touches is inputted in a plurality of determination areas, the touch determining unit 425 may determine the touch inputs to be associated with gripping or holding of the mobile terminal. More specifically, when a plurality of touches is inputted in a plurality of determination areas at the same time or within a predetermined period of time, the touch determining unit 425 may determine the touches to be associated with gripping or holding of the mobile terminal.

Also, even if one or more of the plurality of touch inputs determined to be invalid or associated with gripping or holding of the mobile terminal is released or removed from the determination area, the touch determining unit 425 may maintain its determination with respect to the validity of the detected inputs. More specifically, portions of the determination area in which the invalid touch input was detected may be maintained and allocated as a virtual bezel area. Further, the allocated portions of the determination area in which the touch is released may be configured to be unallocated from the virtual bezel area and reallocated as an active area or a command execution area.

In an example, the touch determining unit 425 may identify a type of the touch based on a size of the touch or an occupied area of the determination area in which the touch is inputted. More specifically, the touch determining unit 425 may estimate the size of the touch or the occupied area using a node point that contacts or corresponds to the touch input detected in the determination area, and may identify a type of the touch input based on a determination of whether the size of the touch or the occupied area satisfies a predetermined value. For example, when the number of node points contacting the touch input detected in the determination area is less than a predetermined number, for example, less than three, the touch determining unit 425 may determine that the size of the touch or the occupied area to be below a reference threshold and may identify the corresponding touch input to be a valid input, such as a touch inputted by a finger. Conversely, when at least three node points contacting the touch input are recognized, the touch determining unit 425 may determine that the size of the touch or the occupied area to be at or above the reference threshold and may identify the corresponding touch input to be an invalid input, such as a touch inputted by a palm. When the touch inputted in the determination is identified to be a touch inputted by a palm or other parts of the body that may be associated with gripping or holding of the mobile terminal, the touch determining unit 425 may determine the touch input to be invalid or a touch associated with the gripping or holding of the mobile terminal.

Also, when a plurality of touch inputs are adjacent to one another and/or are detected within a predetermined period of time or at the same time, the touch determining unit 425 may determine that the plurality of touches to be a multi touch.

When a request to switch the display unit of the mobile terminal to a power ON state is generated, the touch determining unit 425 may determine the inputted touch to be associated with the gripping or holding the mobile terminal irrespective of a type of the touch and may invalidate a touch command associated with the touch input. More specifically, when the power state of the display unit is switched to an ON state while the user grips the touch area of the mobile terminal in an OFF state, the touch determining unit 425 may allocate the area in which the grip is maintained as a virtual bezel area. In an example, the ON state may refer or correspond to a state in which a component of the display unit, such as a back light unit, is powered on to activate the display operation and/or the touch input processing operation. The OFF state may refer to or correspond to a state in which a component of the display unit is powered off to deactivate the display operation and/or the touch input processing operation.

Also, the touch determining unit 425 may maintain the ON state while the touch determined to be associated with a gripping or holding of the mobile terminal is maintained. This may be true even in a situation in which a touch for executing a touch command is not inputted or detected for a predetermined period. Further, the touch determining unit 425 may provide an environment, which enables receiving of an input of a touch, to allow the user to eliminate a pre-processing operation for inputting a touch, for example, a request to switch the display unit of the mobile terminal to the ON state.

The processor 427 may validate or invalidate a touch command associated with the touch. More specifically, when the inputted touch is determined to be associated with the gripping or holding of the mobile terminal, the processor 427 may block further processing and not execute a touch command associated with the touch input. When the touch input is determined not to be associated with the gripping or holding of the mobile terminal, or when the touch is inputted in the touch area other than the determination area, the processor 427 may execute a touch command associated with the touch input.

Also, the processor 427 may adjust the touch area on the display screen of the mobile terminal by re-allocating, as an active area, portions of the determination area other than the portion of determination area converted into the virtual bezel area. For example, the processor 427 may not locate a program icon for executing a program in the virtual bezel area or execute a program that is provided in the display area, which may be different than the virtual bezel area, by an execution command associated with the program icon, for example, a click command.

When a plurality of touch inputs are detected in a pair, at opposing determination areas, the respective touch inputs may be determined to be associated with gripping or holding of the mobile terminal by the touch determining unit 425. In response, the processor 427 may set a display direction or orientation of the display area based on an imaginary line connecting the pair of determination areas.

Referring to FIG. 3B, when two touch inputs are detected in a first determination area A located at the left side, and a second determination area A′ located at the right side are determined to be associated with gripping the mobile terminal, the processor 427 may set a display direction or orientation of the display area based on a first axis. More specifically, a horizontal axis or the first axis that may connect the first determination area A to the second determination area A′. In this example, the processor 427 may set the display direction to be in a horizontal direction or orientation.

Also, when a plurality of touch inputs detected in a pair of adjacent or bordering determination areas is determined to be associated with gripping the mobile terminal by the touch determining unit 425. In response, the processor 427 may change the display direction or orientation of the display area. More specifically, the processor 427 may change the display direction or orientation of the display area based on a direction or orientation in which the user grips the mobile terminal and a direction or orientation in which the user views the mobile terminal. For example, referring to FIG. 3A, when two touch inputs in a first determination area A located at the left side and a third determination area B located at the top side are determined to be associated with gripping the mobile terminal and the display direction or orientation of the display area is set to be in a horizontal direction or orientation, the processor 427 may change the display direction or orientation of the display area to a vertical direction or orientation.

Also, referring again to FIG. 3A, the processor 427 may switch the display direction or orientation of the display area with respect to a first axis or a second axis in the display of the mobile terminal. For example, when a first touch input is detected in a third determination area located adjacent to a first determination area at one end of the second axis is determined to be associated with gripping the mobile terminal, in a state in which a second touch input in the first determination area located at one end of the first axis corresponding to the view direction or orientation is determined to be associated with gripping the mobile terminal, the processor 427 may recognize an intent to switch the display direction or orientation, and may switch the display direction or orientation of the display area to correspond to the second axis.

The setting unit 429 may provide an environment that may enable setting of a size, including a width and height, of the determination area in response to a request to set the size of the determination area. More specifically, the setting unit 429 may, for example, set or adjust the width of the determination area by dragging a border that divides the command execution area from the determination area, or temporarily gripping a portion of the determination area that the user intends to use as a virtual bezel area, in response to a request for setting the width of the determination area. Also, the setting unit 429 may automatically set or adjust the width or height of the determination area in consideration of an area associated with the grip inputted repeatedly for a predetermined period.

Although one or more components of the control unit 420 of FIG. 4 may be configured according to its operation, each component may be integrated with another component to perform a corresponding operation of another component.

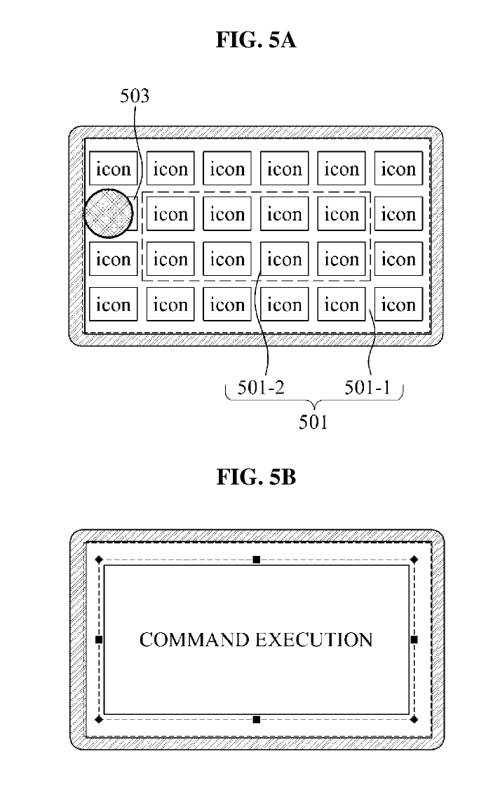

FIG. 5A and FIG. 5B are diagrams illustrating an operation of the mobile terminal according to an exemplary embodiment of the present invention.

Referring to FIG. 5A, the mobile terminal may display, for example, a home view on a touch area 501. In this instance, the mobile terminal may use the touch area 501 without dividing the touch area 501 into a determination area 501-1 and a command execution area 501-2. Accordingly, the mobile terminal may display program icons on the determination area 501-1 as well as the command execution area 501-2.

The mobile terminal may determine whether a touch input detected in the determination area 501-1 is associated or not associated with gripping the mobile terminal. When the touch input is determined not to be associated with gripping the mobile terminal, the mobile terminal may provide an environment that may enable execution of a touch command associated with the touch input. For example, as illustrated in FIG. 5B, the mobile terminal may execute a program corresponding to an icon 503 contacting the touch input. More specifically, if the mobile terminal determines that the touch input corresponding to the icon 503 is a valid input, the mobile terminal may use or allocate the determination area 501-1 as an active area, which may provide similar operations as the command execution area 501-2.

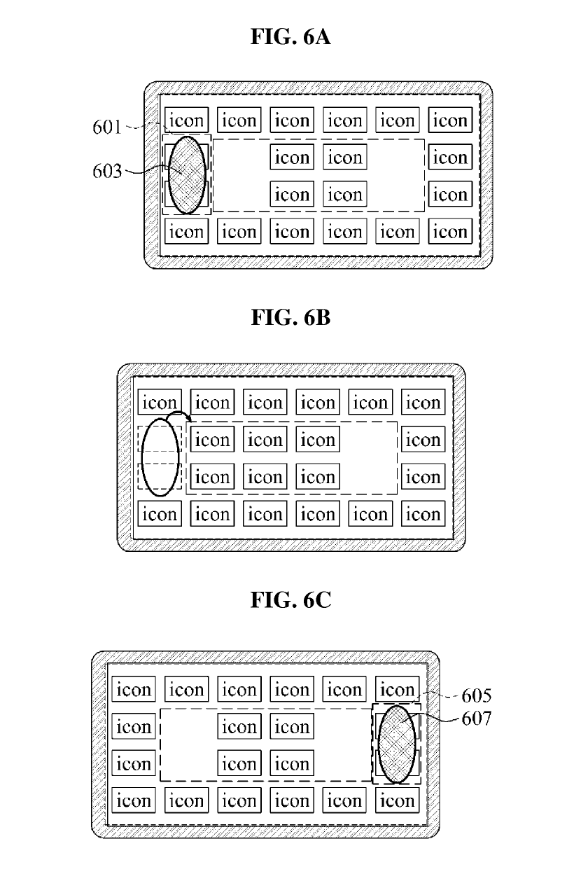

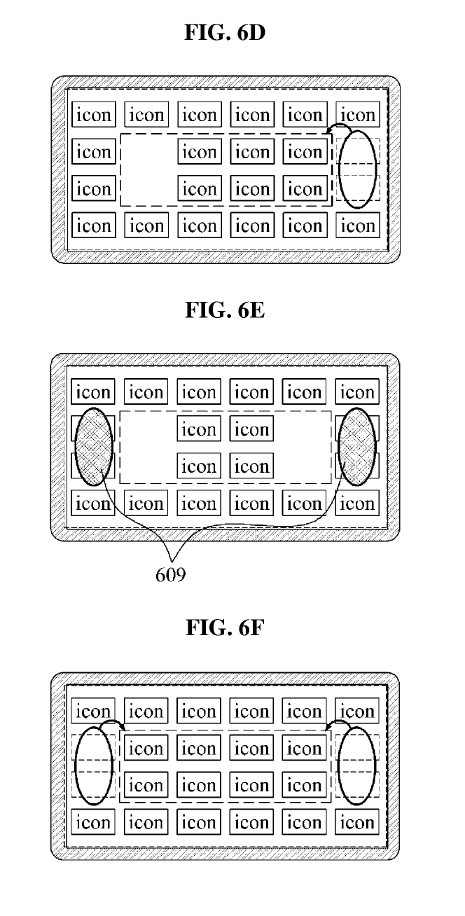

FIG. 6A, FIG. 6B, FIG. 6C, FIG. 6D, FIG. 6E, and FIG. 6F are diagrams illustrating a display control operation of the mobile terminal according to an exemplary embodiment of the present invention.

When a touch input detected in a portion of a determination area is determined to be associated with gripping the mobile terminal or invalid, the mobile terminal may allocate the portion of the determination area in which the invalid touch input is detected as a virtual bezel area. Further, the mobile terminal may allocate, as an active area, portions of the determination area other than the portion of the determination area in which the touch associated with a gripping the mobile terminal is inputted. Accordingly, the allocated active areas may execute commands along with an command execution area, and may also display, on the allocated active area, display information, for example, a program icon for executing a program, information about a program executed on a standby view, such as, for example, information about a media player, and a program execution view.

For example, as shown in FIG. 6A, a touch input 603 is detected in a determination area 601 located at the left side of the touch area may be determined to be associated with gripping the mobile terminal or invalid. When the touch input 603 is determined to be invalid in a home view including a plurality of icons is displayed on the touch area, the mobile terminal may allocate the left determination area 601 in which the touch input 603 is detected as a virtual bezel area, and may allocate other determination areas other than the determination area 601 that is allocated as the virtual bezel as an active area. Since the virtual bezel area may not display information or images, the effective display area may be adjusted to account for the virtual bezel area. Further, icons displayed on the left determination area 601 may be moved to be displayed on the active area. More specifically, the mobile terminal may display the icons on the adjusted display area by shifting the location of the icons, as shown in FIG. 6B. However, aspects of the invention are not limited thereto, such that the icons may be duplicated to be displayed in the active area or the icons may be expanded or stretched to be displayed in the active area.

Also, as shown in FIG. 6C, FIG. 6D, and FIG. 6E, when a touch input 607 is detected in a determination area 605 located at the right side of the touch area, and when a plurality of touch inputs 609 are detected in the determination area 601 and the determination area 605 are determined to be invalid or associated with gripping the mobile terminal on a home view display icons on the touch area, the mobile terminal may allocate other determination areas that did not detect the invalid touch inputs as an active area. Further, the determination area 601 and/or determination area 605 may be allocated as virtual bezel areas, which may not display any images or information thereon, and the effective display area may accordingly be adjusted. The mobile terminal may display icons previously displayed on the allocated virtual bezel areas on the adjusted display area, as shown in FIG. 6D, FIG. 6E, and FIG. 6F.

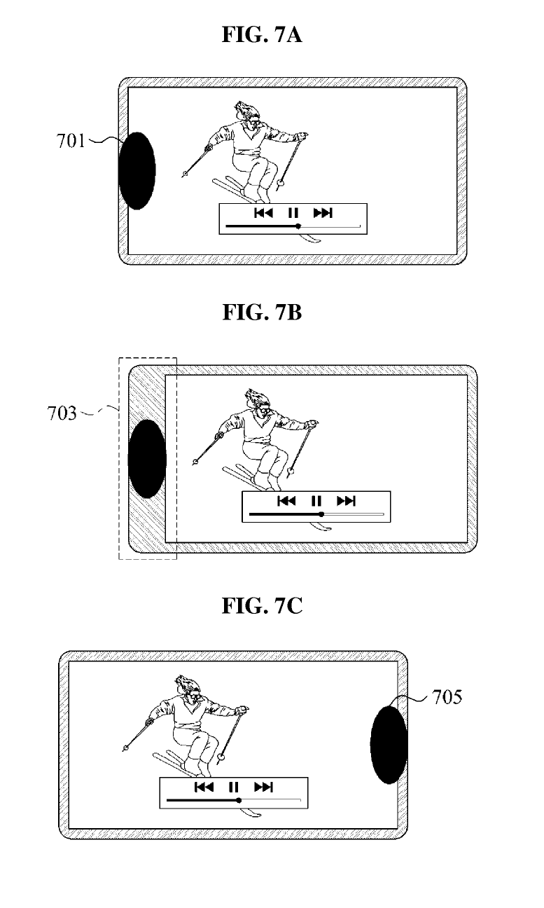

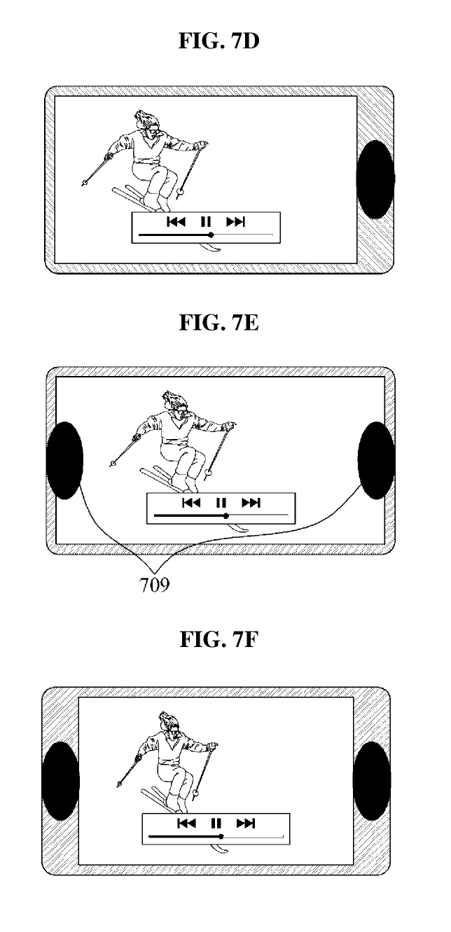

FIG. 7A, FIG. 7B, FIG. 7C, FIG. 7D, FIG. 7E, and FIG. 7F are diagrams illustrating a display control operation of the mobile terminal according to an exemplary embodiment of the present invention.

When a touch input detected in a determination area is determined to be invalid or associated with gripping of the mobile terminal, the mobile terminal may adjust a display area to remove the determination area in which the invalid touch input is detected so that display information may be displayed on the adjusted display area.

As shown in FIG. 7A, when a touch input 701 is detected in a left determination area in the touch area is determined to be invalid in a program execution view, for example, a video play view, the mobile terminal may adjust the program execution view by adjusting the display area to remove the left determination area in which the invalid touch input 701 is detected as shown in FIG. 7B. Here, the left determination area in which the invalid touch input 701 is detected may correspond to a virtual bezel area 703 corresponding to the invalid touch input 701.

More specifically, when the touch 701 inputted in the left determination area in the touch area is determined to be an invalid input in which the program execution view is displayed, the mobile terminal may reduce the program execution view so that display information may be displayed on an adjusted display area not including the virtual bezel area 703 corresponding to the touch input 701. The mobile terminal may adjust the program execution view by reducing the program execution view based on the horizontal or vertical axis or by reducing the program execution view with respect to a predetermined ratio of the horizontal axis and the vertical axis.

Also, as shown in FIG. 7C, FIG. 7D, and FIG. 7E, when a touch input 705 is detected in a right determination area in the touch area and when a plurality of touch inputs 709 detected in both the left determination area and the right determination area in the touch area is determined to be invalid in which a program execution view is displayed on the touch area, the mobile terminal may reduce the program execution view so that display information may be displayed on an adjusted display area not including the determination areas associated with each of the touch input 705 and the touch inputs 709, as shown in FIG. 7D, FIG. 7E, and FIG. 7F. Further, the mobile terminal may adjust the program execution view by reducing the program execution view based on the horizontal or vertical axis or by reducing the program execution view based on both the horizontal axis and the vertical axis.

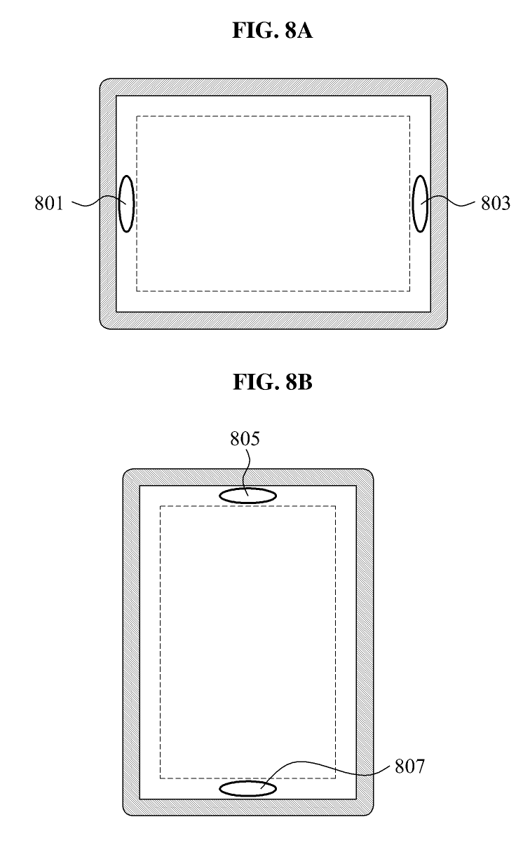

FIG. 8A and FIG. 8B are diagrams illustrating a display direction control of the mobile terminal according to an exemplary embodiment of the present invention.

The mobile terminal may adjust a display direction or orientation of the display area based on a location of a determination area in which an invalid touch input or a touch input associated with gripping of the mobile terminal is detected. This may result in an adjustment of a display direction or orientation in a more convenient manner than adjustment using a change in physical tilt. More specifically, when a touch input detected in each of a pair of opposing determination areas is determined to be invalid, the mobile terminal may set a display direction or orientation of the display area based on a line connecting the pair of determination areas.

For example, as shown in FIG. 8A, when each of touch input 801 and touch input 803 are detected in a first determination area located at the left side of the touch area and a second determination area located at the right side of the touch area, respectively, is determined to be invalid, the mobile terminal may set a display direction or orientation of a display area based on an imaginary line connecting the first determination area to the second determination area. More specifically, the mobile terminal may set a display direction or orientation to be a horizontal direction or orientation based on a horizontal line.

Also, as shown in FIG. 8B, when each of touch input 805 and touch input 807 detected in a first determination area located at the top side of the touch area and a second determination area located at the bottom side of the touch area, respectively, is determined to be invalid, the mobile terminal may set a display direction or orientation of the display area based on a line connecting the first determination area to the second determination area. More specifically, the mobile terminal may set a display direction or orientation to be a vertical direction or orientation based on a vertical line.

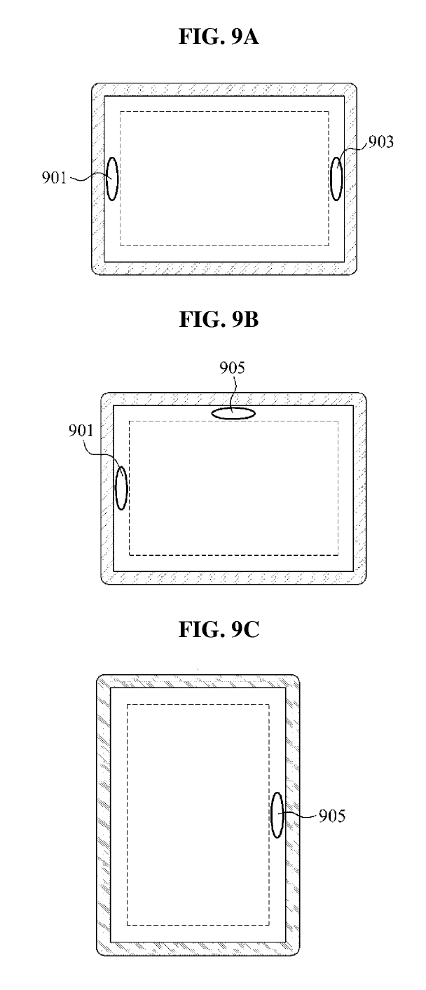

FIG. 9A, FIG. 9B, and FIG. 9C are diagrams illustrating a display direction control of a mobile terminal according to an exemplary embodiment of the present invention.

When each of touch inputs detected in a pair of adjacent determination areas is determined to be associated with gripping of the mobile terminal or invalid, the mobile terminal may change the display direction or orientation of the display area.

For example, as shown in FIG. 9A, when each of touch input 901 and touch input 903 detected in a first determination area located at the left side of the touch area and a second determination area located at the right side of the touch area, respectively, are determined to be invalid, the mobile terminal may set a display direction or orientation of the display area to be a horizontal direction or orientation based on an imaginary line connecting the first determination area to the second determination area, for example, a horizontal line. Even in a situation in which the touch input 903 is released from the second determination area, the mobile terminal may maintain the determination of the touch 901 being maintained in the first determination area to be invalid. More specifically, the area in which the invalid touch input is maintained may continually be allocated as a virtual bezel area. When the determination area in which the touch input 901 is released, the respective determination area that was allocated as a virtual bezel area may be de-allocated from the virtual bezel area and re-allocated as an active area.

Also, as shown in FIG. 9B, when a touch input 905 is detected in a third determination area located at the top side of the touch area, which may be adjacent and perpendicular to the first determination area, while the touch input 901 is maintained in the first determination area, the mobile terminal may change the display direction or orientation from the horizontal direction to a vertical direction as shown in FIG. 9C. The touch input 905 may be determined to be associated with gripping of the mobile terminal or invalid. In this case, the third determination area in which the touch input 905 is detected may be allocated as a virtual bezel area, and the first determination area in which the touch input 901 is detected may be maintained as the allocated virtual bezel area while the touch input 901 is maintained. When the touch input 901 is released, the respective determination area that was allocated as a virtual bezel area may be de-allocated from the virtual bezel area and re-allocated as an active area.

More specifically, when the user inputs a touch in the third determination area using a right hand in a state in which the user maintains a touch input associated with gripping the mobile terminal in the first determination area using a left hand, the mobile terminal may change the display direction or orientation from a horizontal direction or orientation to a vertical direction or orientation based on a change in physical tilt. Although described as adjacent or perpendicular, aspects need not be limited thereto such that the third determination area need not be directly adjacent to and may be separated from one or both of the first and second determination areas and need not be perpendicular thereto.

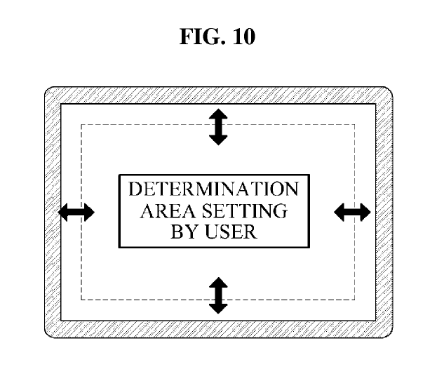

FIG. 10 is a diagram illustrating a determination area setting operation of the mobile terminal according to an exemplary embodiment of the present invention.

Referring to FIG. 10, the mobile terminal may provide an environment that may enable setting a size, including the width and/or height, of the determination area or region in response to a request for setting the size of the determination area or region. In this instance, the mobile terminal may provide a manual setting method or an automatic setting method in response to a request for setting the size of the determination area.

For example, when a dragging operation is selected as the manual setting method, the mobile terminal may set the width or height of the determination area by temporarily displaying a border between a determination area and a command execution area and dragging on the borders of the determination area by a touch of the user. In this instance, the temporary border between the determination area and the command execution area set by the user may be displayed in a specific color or a transparent color for the user to distinguish the areas. Also, the determination area may be set by the user dragging the edges of the touch area inward in a setting mode, or may be set by the user drawing a border for a predetermined area in the display area, without displaying the temporary border. When the determination area is set by drawing a border, an area located at the outside of the border drawn by the user may be set as the determination area. In this instance, a predetermined point may be selected by the user to drag or draw a line. When coordinate values in an axis inputted by the user are not matched with corresponding coordinate values, more specifically, when a selection of the user is misaligned, the determination area may be set by reflecting the selection of the user or by using a predetermined value among the inputted coordinate values, such as a mean value, an outermost value, and an innermost value.

Also, when setting a temporary gripping area is selected as the manual setting method, the mobile terminal may receive a touch input associated with gripping of the mobile terminal to set the size, including width and/or height, of the determination area in consideration of an area associated with the inputted touch. The determination area may be set to an area located at the end portions of an imaginary line connecting both ends of a reference axis based on a central touch point of a touch input associated with gripping of the mobile terminal. The touch point may refer to a coordinate value of a touch channel corresponding to the central touch point of a touch input associated with the gripping of the mobile terminal. Here, the reference axis may correspond to an axis parallel to a side of a bezel adjacent to the touch area corresponding to the inputted touch. More specifically, when the mobile terminal is gripped in a horizontal direction, the reference axis may correspond to the second axis of FIG. 3.

When the mobile terminal is gripped in a vertical direction, the reference axis may correspond to the first axis of FIG. 3. On the other hand, the determination area may be set based on a coordinate value of one or more points corresponding to the touch input associated with the gripping of the mobile terminal. More specifically, when a coordinate value of one or more points corresponding to the touch input inclines toward one end of a predetermined axis, the determination area may be set based on the corresponding axis. For example, if the display unit includes forty x-axis touch channels 0 to 39 and thirty y-axis touch channels 0 to 29, when coordinate values of (0,5), (0,4), (1,3), (1,4), (2,5), and (2,4) corresponding to an (x,y) coordinate, are detected as coordinate values of points corresponding to the touch input associated with the gripping of the mobile terminal, the temporary grip may be determined to be generated adjacent to the touch channel 0 on the x-axis. Accordingly, the determination area may be set from the outermost touch channel to the innermost touch channel in which the touch input may be detected, that is, the touch channel 0 to the touch channel 2 may be set on the x-axis.

When the automatic setting method is selected, the mobile terminal may automatically set the size, including the width and the height, of the determination area in consideration of a portion of the determination area associated with the touch input associated with gripping of the mobile terminal, which may be inputted repeatedly for a predetermined period, for example, one hour, or a predetermined number of times. More specifically, the mobile terminal may calculate an average number times a touch input is repeatedly inputted in the portions of the determination areas associated with the gripping of the mobile terminal, and may automatically set the size of the determination area to a size calculated information.

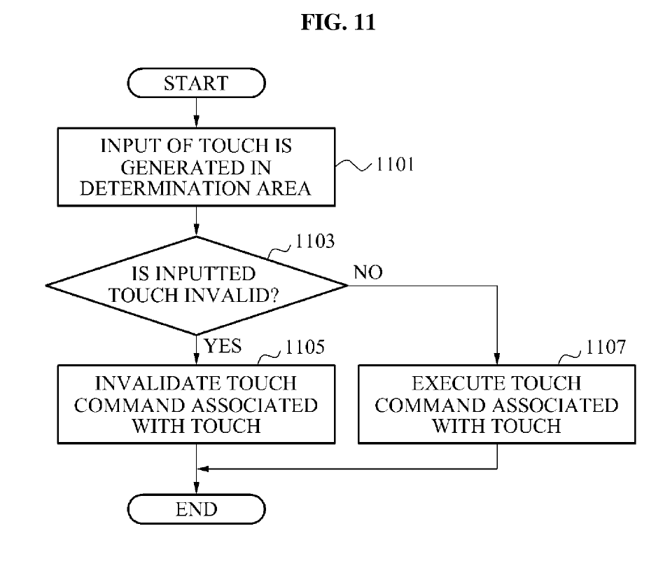

FIG. 11 is a flowchart illustrating a display control method according to an exemplary embodiment of the present invention.

Referring to FIG. 11, in operation 1101, the mobile terminal may receive a touch input in a determination area or region. Before the mobile terminal receives the touch input, the mobile terminal may allocate a predetermined portion of the touch area into determination areas. In an example, the mobile terminal may allocate N number of touch channels located along the edges of the touch area as determination areas based on the width of the touch area or a display area, in which N is a natural number.

The mobile terminal may allocate portions of the touch area as determination areas having a predetermined width. Further, in response to a request to set or adjust the size, including a width and/or height, of the determination area, the mobile terminal may provide an environment that may enable setting or adjusting the size of the determination area. For example, the mobile terminal may set or adjust the width of the determination area by dragging on a border that may divide the determination area from a command execution area, or by temporarily gripping a portion of the touch area and determining a determination area based on the temporary grip. Further, the mobile terminal may automatically set or adjust the size of the determination area in consideration of portions of the touch area associated with repeated touch inputs associated with gripping of the mobile terminal for a predetermined period.

In operation 1103, the mobile terminal may determine whether the touch input detected in the determination area is invalid, such as a touch input associated with gripping of the mobile terminal. When a surface area of the touch input detected in the determination area is determined to satisfy a predetermined value, for example, when the surface area of the determination area is greater than or equal to the predetermined value, the mobile terminal may determine the touch input to be invalid or associated with gripping of the mobile terminal.

Also, when a plurality of touch inputs is detected in the plurality of determination areas at the same time or within a predetermined period of time, the mobile terminal may determine the touch to be invalid or associated with gripping of the mobile terminal. In this instance, even in a situation in which one or more of the plurality of touch inputs may be determined to be invalid is released from the determination area, the mobile terminal may maintain a determination of the other invalid touch inputs.

In operation 1105, when the touch input is determined to be invalid, the mobile terminal may convert at least a portion of the determination area in which the invalid touch input is detected into a virtual bezel area, and may invalidate a touch command associated with the invalid touch input detected in the virtual bezel area. More specifically, the mobile terminal may convert at least a portion of the determination area or portions of the determination area corresponding to the invalid touch input into a virtual bezel area, and may set the other portions of the determination area and the command execution area to be an active area. Also, the mobile terminal may set the entire segment or component of the determination area to be a virtual bezel area if a portion of the respective segment or component is determined to correspond to an invalid touch input. Further, the mobile terminal may set the other segments or components of the determination area that do not correspond to the invalid touch input to be an active area.

When the touch input detected in the determination area is determined to be associated with gripping of the mobile terminal or invalid, the mobile terminal may control or adjust the size of a display area by setting the virtual bezel area and the active area. More specifically, the mobile terminal may not locate or display a program icon in the determination area allocated as the virtual bezel area, display the program icon in the allocated active area, and execute a program corresponding to the program icon in the allocated active area.

Also, when a plurality of touch inputs detected in a pair of opposing determination areas is determined to be invalid, such as a touch input associated with gripping of the mobile terminal, the mobile terminal may set a display direction or orientation of the display area based on an imaginary line connecting the pair of determination areas. In this instance, when a plurality of touch inputs detected in a pair of adjacent determination areas is determined to be invalid, the mobile terminal may change the display direction or orientation of the display area.

In operation 1107, when the touch input detected in the determination area is determined to be valid or not to be associated with gripping of the mobile terminal in operation 1103, the mobile terminal may execute a touch command associated with the touch input.

The exemplary embodiments of the present invention may determine whether a touch inputted in an allocated determination area is associated with gripping of the mobile terminal or invalid, and when the touch input is determined to be invalid, the mobile terminal may invalidate a touch command associated with the invalid touch input, to reduce a likelihood of executing an operation in error caused by gripping or holding the mobile terminal. A separate virtual area in the touch area may be designated for gripping the mobile terminal, such that a physical bezel may be replaced by a virtual bezel area to increase the size of the display area.

The exemplary embodiments of the present invention may allocate, as an active area, a portion of the determination area in the touch area other than the portion of the determination area corresponding to the invalid touch input may be allocated as an active area and display information or images. Further, since portions of images that may be overlapped by an invalid touch may be shifted to the allocated active area, display information may not be concealed by gripping the mobile terminal.

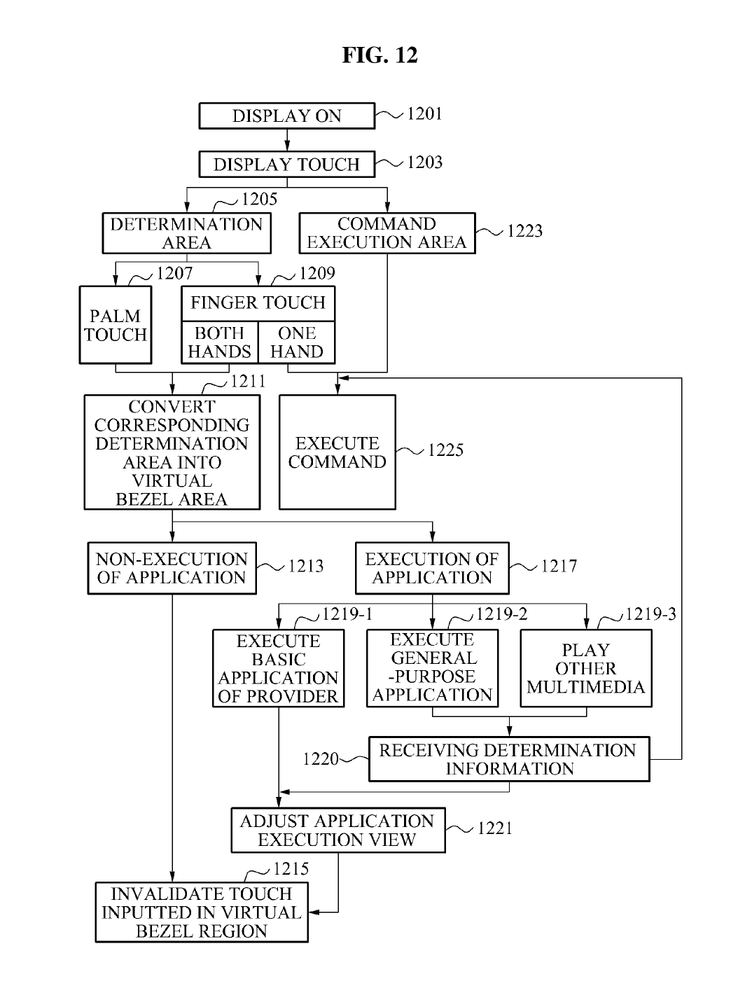

FIG. 12 is a flowchart illustrating an operational structure of a user interface according to an exemplary embodiment of the present invention.

In operation 1201, the mobile terminal may power on a display unit in response to a request to switch the display unit to an ON state. In this instance, both a command execution area and a determination area in a touch area may receive an input of a touch, so that the input of the touch in the command execution area and the determination area may be detected.

In operation 1203, when the touch input is detected, the mobile terminal may identify whether the touch input is detected in the determination area or the command execution area. When the touch input is determined to be detected in the determination area or region, the mobile terminal may perform operation 1205 and subsequent operations. When the touch input is determined to be detected in the command execution area in operation 1223, the mobile terminal may execute a command that corresponds to the detected touch input in operation 1225.

In operation 1205, the mobile terminal may identify a type of the touch. More specifically, the mobile terminal may determine whether the inputted touch is a valid touch input or an invalid touch input. Referring to FIG. 12, the mobile terminal may determine whether the detected touch input was inputted with parts of user's body that may be associated with gripping the mobile terminal, such as a palm or fingers belonging to both hands.

When the touch input is determined to be a touch inputted by a user's palm in operation 1207, or the touch input is identified to be a touch inputted with fingers belonging to both hands in operation 1209, the mobile terminal may convert at least the portion of the determination area corresponding to the touch inputs described above into a virtual bezel area. Further, the mobile terminal may convert the entire section or component of the corresponding determination area into a virtual bezel area or region in operation 1211.

Subsequently, the mobile terminal may perform a predetermined command or operation based on whether the touch input corresponds to a command that is associated with execution or non-execution of an application on the display of the mobile terminal.

When an application is not executed in the mobile terminal in response to the detected touch input in operation 1213, the mobile terminal may invalidate a command associated with the detected touch input in the converted virtual bezel area. In this instance, the mobile terminal may move a program icon, a command execution icon, and other relevant icons or images from the virtual bezel area, to an active area. The mobile terminal may also shift or adjust the display area in consideration of the virtual bezel area, such that the icons and images that may be concealed, at least in part, by the touched input may be located within the active area or the adjusted display area.

When an application is executed in the mobile terminal in response to detected touch input in operation 1217, the mobile terminal may identify a type of the application being executed. More specifically, the mobile terminal may determine whether the application being executed is a basic application of a provider, a general purpose application, or a multimedia application. However, aspects of the invention are not limited thereto, such that the type of the application may include a messaging application, a gaming application, and the like.

When the application being executed is determined as the basic application of a provider in operation 1219-1, the mobile terminal may shift or reduce the size of the entire application execution view or the display area in consideration of the virtual bezel area, such that the entire application execution view or the display area may be located within the active area in operation 1221. When the mobile terminal reduces the application execution view or the display area, the mobile terminal may reduce the application execution view with respect to a predetermined ratio of a horizontal axis and/or a vertical axis. Next, the mobile terminal may move to operation 1215 to invalidate the touch inputted in the virtual bezel area or region.

When the application being executed is determined as the general-purpose application or other multimedia in operation 1219-2 and operation 1219-3, respectively, the mobile terminal may request the user to input determination information as to whether to use the touch inputted in the virtual bezel area in operation 1220. When the user inputs determination information to use the touch inputted in the virtual bezel area, the method may proceed to operation 1225 to execute a command associated with the touch. When the user determines not to use the touch input detected in the virtual bezel area, the mobile terminal may adjust the application execution view in operation 1221 and may invalidate the touch input detected in the virtual bezel area in operation 1215.

The mobile terminal may shift or reduce the application execution view or the display area irrespective of a type of the application including a basic application of a provider, a general-purpose application, and other multimedia. When the mobile terminal receives determination information about whether to use the touch input detected in the virtual bezel area, the mobile terminal may perform a predetermined operation based on the input or the type of application. Also, the mobile terminal may move the application execution view or the display area to the active area during execution of the application.

When the touch input is determined to a touch inputted in the active area, but not in the determination area, in operation 1203, or when the touch is identified to be a touch inputted by a finger of a single hand in operation 1209, or when the touch input is determined to be used in response to a request for inputting determination information about whether to use the touch input based on a type of an application being executed, the mobile terminal may determine the touch input to be a valid touch and execute a corresponding event or command associated with the touch input in operation 1225.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media, such as hard discs, floppy discs, and magnetic tape; optical media, such as CD ROM discs and DVD; magneto-optical media, such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the exemplary embodiments of the present invention, a likelihood of incurring an error caused by an unintended touch input caused by gripping the mobile terminal in the touch area may be reduced by determining whether the inputted touch input detected in a determination area is associated with gripping of the mobile terminal or invalid, and by invalidating a touch command associated with the touch input when the touch is determined to be associated with gripping of the mobile terminal.

According to exemplary embodiments of the present invention, an active area may be increased by converting a portion of the determination area corresponding to a touch input associated with gripping of the mobile terminal into a virtual bezel area.

According to exemplary embodiments of the present invention, display information may be displayed on a display area other than a portion of the determination area in which a touch input detected is determined to be associated with gripping of the mobile terminal, thereby reducing the likelihood display information from being concealed by gripping the mobile terminal.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for controlling an active area of a display unit, comprising:
detecting a first touch input on a touch area of the display unit;
determining validity of the first touch input;
converting at least a portion of the touch area corresponding to the first touch input to a virtual bezel area if the first touch input is determined to be invalid; and
performing a command based on the validity of the first touch input.

2. The method claim 1, further comprising:
adjusting the active area of the display unit if the first touch input is determined to be invalid,
wherein the active area is adjusted with respect to the virtual bezel area.

3. The method of claim 2, wherein the active area is adjusted to display information located in the virtual bezel area.

4. The method of claim 1, wherein the first touch input is determined to be invalid if the first touch input is associated with gripping of the mobile terminal.

5. The method of claim 4, wherein the first touch input is determined to be associated with the gripping of the mobile terminal based on a size of a surface area of the first touch input.

6. The method of claim 4, wherein the first touch input is determined to be associated with the gripping of the mobile terminal if the first touch input is detected on a first determination area of the display unit and a second touch input is detected on a second determination area of the display unit within a reference period of time.

7. The method of claim 1, further comprising:
determining whether the first touch input is associated with an executed application; and
determining a type of the application when the first touch input is determined to be associated with the executed application,
wherein the active area is adjusted if the type of the application is of a first type, and
a determination information is requested if the type of the application is of a second type.

8. The method of claim 7, wherein a command corresponding to the first touch input is invalidated in response to the determination information.

9. The method of claim 7, wherein a command corresponding to the first touch input is executed in response to the determination information.

10. The method of claim 1, wherein a command corresponding to the first touch input is invalidated if the first touch input is determined to be invalid.

11. The method of claim 1, further comprising changing a first orientation of a display area of the display unit to a second orientation in response to detecting a second touch input on the touch area of the display unit,
wherein the touch area of the first touch input is adjacent to the touch area of the second touch input.

12. The method of claim 1, further comprising setting a determination area, a detected touch input being valid according to whether the detected touch input is located in the determination area.

13. A mobile terminal, comprising:
a display unit comprising an active area;
a touch input unit to detect a first touch input on a touch area of the display unit; and
a control unit to determine validity of the detected first touch input, to convert at least a portion of the touch area corresponding to the first touch input to a virtual bezel area if the first touch input is determined to be invalid, and to perform a command based on the validity of the first touch input.

14. The mobile terminal of claim 13, wherein the control unit adjusts the active area if the first touch input is determined to be invalid,
wherein the active area is adjusted with respect to the virtual bezel area.

15. The mobile terminal of claim 13, wherein the active area is adjusted to display information located in the virtual bezel area.

16. The mobile terminal of claim 13, wherein the first touch input is determined to be invalid if the first touch input is associated with gripping of the mobile terminal.

17. The mobile terminal of claim 16, wherein the first touch input is determined to be associated with the gripping of the mobile terminal based on a size of a surface area of the first touch input.

18. The mobile terminal of claim 16, wherein the first touch input is determined to be associated with the gripping of the mobile terminal if the first touch input is detected on a first determination area of the display unit and a second touch input is detected on a second determination area of the display unit within a reference period of time.

19. The mobile terminal of claim 13, wherein the control unit:
determines whether the first touch input is associated with an executed application; and
determines a type of the application when the first touch input is determined to be associated with the executed application,
wherein the active area is adjusted if the type of the application is of a first type, and a determination information is requested if the type of the application is of a second type.

20. The mobile terminal of claim 19, wherein a command corresponding to the first touch input is invalidated in response to the determination information.

21. The mobile terminal of claim 19, wherein a command corresponding to the first touch input is executed in response to the determination information.

22. The mobile terminal of claim 13, wherein a command corresponding to the first touch input is invalidated if the first touch input is determined to be invalid.

23. The mobile terminal of claim 13, wherein the touch input unit detects a second touch input on the touch area of the display unit, and
the control unit changes a first orientation of a display area to a second orientation in response to the second touch input,
wherein the touch area of the first touch input is adjacent to a touch area of the second touch input.

24. The mobile terminal of claim 13, wherein the display unit further comprises a determination area, and a detected touch is valid according to whether the detected touch is located in the determination area.

25. A method for controlling an active area of a display unit, comprising:
detecting a touch input on a determination area of the display unit;
determining whether the touch input is associated with gripping a mobile terminal;
converting at least a portion of the determination area corresponding to the touch input to a virtual bezel area if the touch input is determined to be associated with gripping the mobile terminal;
invalidating a command corresponding to the touch input; and
adjusting the active area with respect to the virtual bezel area.
